(19) United States
(12) Patent Application Publication
(10) Pub. No.: US 2026/0217315 A1
(43) Pub. Date: Jul. 30, 2026

(54) Rear Floor Structure for a Motor Vehicle

(71) Applicant: Bayerische Motoren Werke Aktiengesellschaft, Muenchen (DE)

(72) Inventor: Moritz FRENZEL, Muenchen (DE)

(21) Appl. No.: 19/145,535

(22) PCT Filed: Mar. 6, 2024
(86) PCT No.: PCT/DE2024/100183

§ 371 Date: Jul. 3, 2025

(30) Foreign Application Priority Data
Mar. 30, 2023 (DE) 10 2023 108 200.0

(51) Int. Cl. B62D 21/00; B60K 1/04; B62D 29/00

(52) U.S. Cl. CPC B62D 21/00; B60K 1/04; B62D 29/008; B60K 2001/0438

(57) ABSTRACT

A rear floor structure for a motor vehicle, which is configured in one piece as a high-pressure die cast part, and comprises an annular portion for receiving a flat region of a drive battery of the motor vehicle, and a right-hand (in the motor vehicle width direction) and a left-hand (in the motor vehicle width direction) cast node which each extend to the rear in the motor vehicle longitudinal direction, starting from the annular portion, and form a receptacle for a wheel arch. A rigidity of the annular portion increases, in at least one portion thereof, from an outer side in the radial direction of the annular portion to an inner side in the radial direction of the annular portion.

### BACKGROUND AND SUMMARY

The present disclosure relates to a rear floor structure for a motor vehicle, and a motor vehicle comprising the rear floor structure.

DE 10 2008 062 008 A1 relates to a body structure of a rear section of a motor vehicle, wherein the body structure comprises two side walls, a bulkhead with a floor-side crossmember, and a floor, in each case made of a light metal material.

For some time now, however, body designs having an (aluminum) high-pressure die casting of significantly larger size and shape have been tested in many vehicles, in particular in electric vehicles driven by battery (battery electric vehicles, BEVs).

Reference is made to WO 2022/223204 A1 which relates to a rear structure for a motor vehicle comprising two longitudinal members, a front crossmember and a rear crossmember. The front crossmember and the rear crossmember connect the longitudinal members to one another. The rear structure is a high-pressure die cast component which is cast integrally.

Reference is also made to WO 2022/031991 A1 which describes an integrated energy absorbing system of a vehicle with a front integrated energy absorbing cast part and a rear integrated energy absorbing cast part. Both the front and the rear cast part are designed as a single, uniform or one-piece cast part which forms the integrated energy absorption system. The cast parts consist of ribbed portions such as “I-profiles” and “C-profiles” which are produced with different techniques and/or shapes, such as cutouts, wave-shaped profiles, tapered portions, widened portions and/or rib spacings. Additional portions, such as cast parts with a closed cross section, can also be integrated in the integrated energy absorbing system.

In this context, reference is made to the fact that the functional requirements for the entire vehicle or the body structure are various and complex. They result from rigidity requirements for acoustics, driving dynamics, etc. and in particular from the crash requirements.

The brittle material behavior of the (aluminum) high-pressure die casting represents a particular challenge for the crash design of (aluminum) high-pressure die castings of different sizes and shapes.

Against the background of this prior art, an object of the present disclosure is to specify a device which is suitable for enriching the prior art.

A specific object of the disclosure can be seen in providing a rear floor structure for a motor vehicle which is designed as a one-piece or integral high-pressure die cast part and which does not react with structural failure, such as rupture, even in the case of a high impulse due to a crash load.

Accordingly, this object is achieved by a rear floor structure for a motor vehicle, which is configured in one piece as a high-pressure die cast part, and comprises an annular portion for receiving a flat region of a drive battery of the motor vehicle and a right-hand (in the motor vehicle width direction) and a left-hand (in the motor vehicle width direction) cast node which, in each case in the motor vehicle longitudinal direction, extend to the rear in the motor vehicle longitudinal direction, starting from the annular portion, and form a receptacle for a wheel arch. A rigidity of the annular portion increases, in at least one portion thereof, from an outer side in the radial direction of the annular portion to an inner side in the radial direction of the annular portion.

In other words, a rear structure of a motor vehicle is provided as an integrally cast high-pressure die cast component. This high-pressure die cast component can be divided into a front and a rear region in the motor vehicle longitudinal direction, wherein the front region of the rear structure can be arranged upstream of a rear axle of the motor vehicle and above a drive battery of the motor vehicle. The rear region of the rear structure is arranged on and downstream of the rear axle of the motor vehicle and in the installed state receives the two rear wheels of the motor vehicle by one respective left-hand or right-hand cast node which can also be denoted as longitudinal members. These two cast nodes are connected by a crossmember to which the annular portion forming the front part of the rear structure is connected (when viewed from the motor vehicle vertical direction). The annular portion can have an annular inner circumference and an annular outer circumference.

As a rigidity of the annular portion increases in at least one portion thereof, starting from an outer side in the radial direction of the annular portion, which can also be denoted as soft on the outside and hard or rigid on the inside, an energy is initially absorbed by the outer part of the annular portion in the radial direction, in particular in the event of a side crash or pole crash, so that it is possible to avoid a rupture in the annular portion due to the brittle properties of the material (in particular aluminum) forming the annular portion.

Possible developments of the above-described device are explained in detail hereinafter.

It is conceivable that the annular portion has a honeycomb-like structure on an upper side and/or lower side thereof in the motor vehicle vertical direction in the at least one portion thereof, the honeycomb-like structure being formed by ribs standing on a base surface.

A number of ribs which form the honeycomb-like structure can be smaller on the outer side in the radial direction of the annular portion than on the inner side in the radial direction of the annular portion.

It is conceivable that the number of ribs which form the honeycomb-like structure changes abruptly in the radial direction of the annular portion such that the rigidity of the annular portion also increases abruptly in the radial direction thereof.

A geometry of the ribs which form the honeycomb-like structure can change in the radial direction of the annular portion such that the rigidity of the annular portion increases, optionally abruptly, in the at least one portion thereof from the outer side in the radial direction of the annular portion to the inner side in the radial direction of the annular portion.

A wall thickness of the ribs which form the honeycomb-like structure can change in the radial direction of the annular portion such that the rigidity of the annular portion increases, optionally abruptly, in the at least one portion thereof from the outer side in the radial direction of the annular portion to the inner side in the radial direction of the annular portion.

A wall thickness of the base surface can change in the radial direction of the annular portion such that the rigidity of the annular portion increases, optionally abruptly, in the at least one portion thereof from the outer side in the radial direction of the annular portion to the inner side in the radial direction of the annular portion.

It is conceivable that the at least one portion is arranged at least in a front, right-hand and/or left-hand region of the annular portion in the motor vehicle longitudinal direction.

It is conceivable that the high-pressure die cast part is an aluminum high-pressure die cast part.

That described above can be summarized in other words and in a possible, more specific, embodiment of the disclosure as described hereinafter, wherein the following description is not to be interpreted as limiting the disclosure.

According to the disclosure, an aluminum high-pressure die cast part is provided as a “large casting”. In order to fulfill crash requirements, the design principle “rigid on the inside, soft on the outside” can be regarded as an essential feature of this aluminum high-pressure die casting structure. The design of the aluminum high-pressure die casting structure, i.e. the rib geometry and rib wall thickness and base surface wall thickness, can be designed such that it is even possible to transfer crash loads which act due to barriers or posts in the immediate vicinity of the aluminum high-pressure die casting structure on the body or the entire vehicle. In other words, for large casting designs it is proposed to design the rib structures in the crash region (for example at the side for a post crash) according to the principle “soft on the outside, rigid on the inside” and thus to fulfill crash requirements and to prevent a complete structural break.

Moreover, a motor vehicle is provided with the above-described rear floor structure.

The motor vehicle can be a passenger motor vehicle, in particular an automobile, or a utility vehicle, such as for example a truck. The motor vehicle can be an electric vehicle, for example a purely electric vehicle or a hybrid vehicle.

The motor vehicle can have, in addition to the floor structure, a drive battery, for example in the form of a high voltage storage device, which is arranged on a floor of the motor vehicle and has a flat region which is enclosed by the annular portion of the rear floor structure. The drive battery can supply electrical energy to an electric motor serving as a primary or secondary drive of the motor vehicle.

That described above with reference to the rear floor structure also applies analogously to the motor vehicle and vice versa.

### BRIEF DESCRIPTION OF THE DRAWINGS

FIG. 1 shows schematically in a perspective view a motor vehicle with a rear floor structure according to the disclosure; and,

FIG. 2 shows schematically in a perspective view a section of the floor structure of FIG. 1 in detail.

### DETAILED DESCRIPTION OF THE DRAWINGS

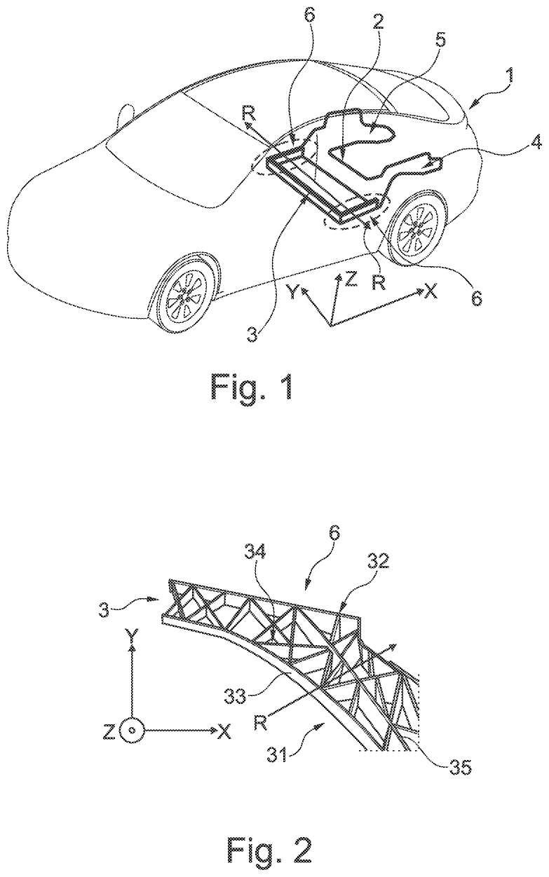

A cartesian coordinate system having an X-axis running in the motor vehicle longitudinal direction X (from front to back or counter to a main direction of travel of the motor vehicle 1), a Y-axis running in the motor vehicle width direction Y and a Z-axis running in the motor vehicle vertical direction Z (from bottom to top) is shown in each case in both FIGS. 1 and 2.

The motor vehicle 1, which is shown merely schematically in FIG. 1, comprises a rear floor structure 2, which is configured in one piece as an aluminum high-pressure die cast part, and comprises an annular portion 3 for receiving a flat region of a drive battery (not shown) of the motor vehicle 1. The floor structure 2 further comprises a right-hand (in the motor vehicle width direction Y) and a left-hand (in the motor vehicle width direction Y) cast node 4, 5 which in each case in the motor vehicle longitudinal direction X extend to the rear in the motor vehicle longitudinal direction X, starting from the annular portion 3, and form a receptacle for a wheel arch (not shown) of the motor vehicle 1.

The annular portion 3 is characterized in that a rigidity of the annular portion 3 increases, in at least one portion 6 thereof, which is shown in FIG. 2 in detail and is arranged in a right-hand and/or left-hand region of the annular portion 3, from an outer side 32 in the radial direction R of the annular portion 3 to an inner side 31 in the radial direction R of the annular portion.

This is implemented in the present case by the floor structure 2 having a honeycomb-like structure on an upper side and/or lower side thereof in the motor vehicle vertical direction in the portion 6, the honeycomb-like structure being formed by ribs 34 standing on a base surface 33 of the floor structure 3. A number of ribs 34 (per unit area) which form the honeycomb-like structure is smaller on the outer side 32 in the radial direction R of the annular portion 3 than on the inner side 31 in the radial direction R of the annular portion 3, and increases abruptly (see the line 35) such that the rigidity of the annular portion 3 also increases abruptly in the radial direction R thereof.

The variation of the number of ribs (per unit area) in the radial direction, however, is only one possible measure in order to implement the difference in rigidity from the inner side 31 to the outer side 32. In addition or alternatively, a geometry and/or a wall thickness of the ribs 33 which form the honeycomb-like structure change in the radial direction of the annular portion such that the rigidity of the annular portion 3 increases, optionally abruptly, in the portion 6 from the outer side 32 in the radial direction R of the annular portion 3 to the inner side 31 in the radial direction R of the annular portion 3. Additionally or alternatively, a wall thickness of the base surface 33 can change in the radial direction R of the annular portion 3 such that the rigidity of the annular portion 3 increases, optionally abruptly, in the portion 6 from the outer side 32 in the radial direction R of the annular portion 3 to the inner side 31 in the radial direction R of the annular portion 3.

### LIST OF REFERENCE SIGNS

1 Motor vehicle
2 Rear floor structure
3 Annular portion
31 Inner side
32 Outer side
33 Base surface
34 Ribs
35 Dividing line
4, 5 Cast nodes
6 Portion having a greater rigidity radially inwardly than radially outwardly
X Motor vehicle longitudinal direction
Y Motor vehicle width direction
Z Motor vehicle vertical direction

1.-10. (canceled)

11. A rear floor structure for a motor vehicle, which is configured in one piece as a high-pressure die cast part, and comprises:
an annular portion for receiving a flat region of a drive battery of the motor vehicle, and
a right-hand and a left-hand cast node which in each case in the motor vehicle longitudinal direction extend to the rear in the motor vehicle longitudinal direction, starting from the annular portion, and form a receptacle for a wheel arch,
wherein a rigidity of the annular portion increases, in at least one portion thereof, from an outer side in the radial direction of the annular portion to an inner side in the radial direction of the annular portion.

12. The rear floor structure according to claim 11, wherein the annular portion has a honeycomb-like structure on an upper side and/or lower side thereof in the motor vehicle vertical direction in the at least one portion thereof, the honeycomb-like structure being formed by ribs standing on a base surface.

13. The rear floor structure according to claim 12, wherein a number of ribs which form the honeycomb-like structure is smaller on the outer side in the radial direction of the annular portion than on the inner side in the radial direction of the annular portion.

14. The rear floor structure according to claim 13, wherein the number of ribs which form the honeycomb-like structure changes abruptly in the radial direction of the annular portion such that the rigidity of the annular portion also increases abruptly in the radial direction thereof.

15. The rear floor structure according to claim 12, wherein a geometry of the ribs which form the honeycomb-like structure changes in the radial direction of the annular portion such that the rigidity of the annular portion increases in the at least one portion thereof from the outer side in the radial direction of the annular portion to the inner side in the radial direction of the annular portion.

16. The rear floor structure according to claim 12, wherein a wall thickness of the ribs which form the honeycomb-like structure change in the radial direction of the annular portion such that the rigidity of the annular portion increases in the at least one portion thereof from the outer side in the radial direction of the annular portion to the inner side in the radial direction of the annular portion.

17. The rear floor structure according to claim 12, wherein a wall thickness of the base surface changes in the radial direction of the annular portion such that the rigidity of the annular portion increases in the at least one portion thereof from the outer side in the radial direction of the annular portion to the inner side in the radial direction of the annular portion.

18. The rear floor structure according to claim 11, wherein the at least one portion is arranged at least in a front region in the motor vehicle longitudinal direction and a right-hand and/or left-hand region of the annular portion in the motor vehicle width direction.

19. The rear floor structure according to claim 11, wherein the high-pressure die cast part is an aluminum high-pressure die cast part.

20. A motor vehicle comprising the rear floor structure according to claim 11.
